(19) United States
(12) Patent Application Publication
(10) Pub. No.: US 2026/0011719 A1
(43) Pub. Date: Jan. 8, 2026

(54) NEGATIVE ELECTRODE FOR RECHARGEABLE BATTERY AND MANUFACTURING METHOD THEREOF

(71) Applicant: SAMSUNG SDI CO., LTD., Yongin-si (KR)

(72) Inventor: Yeongap KIM, Yongin-si (KR)

(21) Appl. No.: 19/244,457

(22) Filed: Jun. 20, 2025

(30) Foreign Application Priority Data
Jul. 8, 2024 (KR) 10-2024-0089826

(51) Int. Cl. H01M 4/36; H01M 4/02; H01M 4/04; H01M 4/587; H01M 10/052

(52) U.S. Cl. CPC H01M 4/366; H01M 4/0404; H01M 4/043; H01M 4/587; H01M 10/052; H01M 2004/027

(57) ABSTRACT

A negative electrode for a rechargeable battery includes: a substrate; and an active material layer on the substrate and including a lower layer and an upper layer on the lower layer and having a plurality of holes with an inclined sidewall, the lower layer includes a first oriented portion, and the upper layer includes second oriented portions and a non-oriented portion between the second oriented portions.

### CROSS-REFERENCE TO RELATED APPLICATION

The present application claims priority to and the benefit of Korean Patent Application No. 10-2024-0089826, filed on Jul. 8, 2024, in the Korean Intellectual Property Office, the entire content of which is incorporated herein by reference.

### BACKGROUND

### 1. Field

Embodiments of the present disclosure relate to an electrode for a battery, and for example, to a negative electrode for a rechargeable battery, and a manufacturing method therefor.

### 2. Description of the Related Art

With advancements in technology and the growing demand for mobile devices, the need or desire for rechargeable batteries as an energy (power) source is on the rise.

A rechargeable battery may be constructed by placing an electrode assembly, which involves positioning electrodes at either side (e.g., opposite sides) of a separator and winding it in the form of a jelly roll, or by stacking sheet-shaped electrodes and a separator. The assembly in then placed in a case together with an electrolyte, and the case opening (an opening of the case) is sealed with a cap assembly.

Positive and negative electrodes of rechargeable batteries may contain active materials capable of intercalation and deintercalation of lithium ions. Transition metal compounds such as lithium cobalt oxide, lithium nickel oxide, and/or lithium manganese oxide are, for example, used as positive active materials, and carbon-based active materials such as crystalline carbon or amorphous carbon, and/or silicon-based active materials are, for example, mainly used as negative active materials.

These rechargeable batteries are desired or required to have relatively high energy densities and fast charging characteristics in order to be applied to various products. However, high energy density and fast charging characteristics have an inversely proportional relationship, so it is not easy to satisfy them concurrently (e.g., simultaneously).

In order to realize high energy densities, development is progressing to manufacture thick film electrodes by increasing an amount of active material on a current collector through lading, and as film thickening becomes more severe, it becomes difficult to secure adhesion or conductivity of an electrode active material layer, and battery performance and the fast charging characteristics may deteriorate. That is, to achieve high energy densities, development is focusing on manufacturing thick film electrodes by increasing the amount of active material on a current collector, but as the film thickens, maintaining adhesion or conductivity of the electrode active material layer becomes challenging, negatively impacting battery performance and fast charging characteristics.

The above-described information disclosed in the background technology of this disclosure is only for improving understanding of the background of the present disclosure, and therefore may include information that does not constitute prior art.

### SUMMARY

Aspects of one or more embodiments of the present disclosure are directed toward a negative electrode for a rechargeable battery and a manufacturing method for the same, in which battery performance and a fast charging characteristic do not deteriorate even when film thickening is carried out to realize high energy density of the rechargeable battery.

Additional aspects will be set forth in part in the description which follows and, in part, will be apparent from the description, or may be learned by practice of the presented embodiments of the disclosure.

One or more embodiments of the present disclosure provides a negative electrode for a rechargeable battery, including: a substrate; and an active material layer on the substrate and including a lower layer and an upper layer on the lower layer and having a plurality of holes with an inclined sidewall (e.g., holes with inclined sidewalls), wherein the lower layer includes a first oriented portion, and the upper layer includes second oriented portions and a non-oriented portion between the second oriented portions.

In one or more embodiments, a long axis of active material particles in the second oriented portions may be oriented in a direction parallel to the inclined sidewall.

In one or more embodiments, the first oriented portion may be denser than the non-oriented portion.

In one or more embodiments, the inclined sidewall may be inclined at an angle of about 30 to about 75 degrees with respect to a surface of the substrate.

In one or more embodiments, the first oriented portion may be oriented by a magnetic field.

In one or more embodiments, the first oriented portion and the second oriented portions may have different orientation angles.

In one or more embodiments, a thickness of the lower layer may be less than about ½ of an entire thickness of the active material layer.

In one or more embodiments, a diameter of the hole of the plurality of holes may become narrower toward the lower layer (e.g., the diameter of the holes may become narrower as they approach the lower layer-in this context, “diameter” refers to the measurement of each individual hole).

In one or more embodiments, the hole may have a cone or polygonal shape.

One or more embodiments of the present disclosure provides a manufacturing method for a negative electrode, including: forming an active material layer on a substrate; forming a first oriented portion by orienting the active material layer using a magnetic field; pressurizing the active material layer with a pressurizing device having a protrusion; inserting the protrusion into the active material layer, and forming a hole by removing the pressurizing device, wherein, when the protrusion is inserted into the active material layer, active material particles of the active material layer are pushed out by the protrusion and are aligned to form a second oriented portion.

In one or more embodiments, an orientation angle of active material particles in the second oriented portion may be different from an orientation angle of active material particles in the first oriented portion.

In one or more embodiments, the protrusion may decrease in width toward an end thereof.

According to one or more embodiments of the present disclosure, by performing orientation in different ways depending on a position thereof, a Li ion movement path may be physically provided at an upper portion and a lower portion of the active material layer, thereby widening and shortening a lithium ion diffusion path and producing a rechargeable battery with an improved rapid charging characteristic.

In one or more embodiments, due to an increase in a reaction area of ions, a lithium (Li) precipitation phenomenon may be reduced and a rapid charge lifespan may be improved.

Aspects of one or more embodiments of the present disclosure are directed toward a negative electrode for a rechargeable battery and a manufacturing method for the same, in which battery performance and fast charging characteristics do not deteriorate even when film thickening is carried out to realize high energy density. By performing orientation in different ways depending on the position, a Li ion movement path may be physically provided at both the upper and lower portions of the active material layer, thereby widening and shortening the lithium ion diffusion path, which improves rapid charging characteristics. Additionally, due to an increased reaction area of ions, lithium (Li) precipitation may be reduced, enhancing the rapid charge lifespan.

### BRIEF DESCRIPTION OF THE DRAWINGS

The following drawings illustrate embodiments of the present disclosure, and together with the detailed description of the disclosure described in more detail below, serve to provide a further understanding of the present disclosure, and thus the present disclosure should not be construed as limited to only the matters depicted in such drawings. In the drawings:

FIG. 1 is a top plan view showing a negative electrode included in a rechargeable battery according to one or more embodiments of the present disclosure.

FIG. 2 is a cross-sectional view taken along the line II-II′ of FIG. 1, according to one or more embodiments of the present disclosure.

FIG. 3 is a cross-sectional view for describing a region of an active material layer according to one or more embodiments of the present disclosure.

FIG. 4 is a schematic view for describing magnetic field orientation of a negative active material according to one or more embodiments of the present disclosure.

FIG. 5 and FIG. 6 are each a cross-sectional view for describing a method of forming a second orientation portion according to one or more embodiments of the present disclosure.

FIG. 7 is a schematic perspective view of a rechargeable battery according to one or more embodiments of the present disclosure.

FIG. 8 is a schematic perspective view of a rechargeable battery according to one or more embodiments of the present disclosure.

FIG. 9 is a cross-sectional view taken along the line IX-IX′ of FIG. 8, according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, embodiments of the present disclosure will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

It will be further understood that the terms “comprises,” “comprising,” “includes,” “including,” “have,” “having,” “contain,” and “containing,” when used in this specification, specify the presence of the stated features, integers, steps, operations, elements, and/or components, but do not preclude the presence or addition of one or more other features, integers, steps, operations, elements, components, and/or groups thereof.

In the drawings, the relative sizes of elements, layers, and regions may be exaggerated for clarity. In addition, to facilitate understanding of the disclosure, the attached drawings may not be drawn to actual scale and the dimensions of some components may be exaggerated. Unless otherwise noted, like reference numerals denote like elements throughout the attached drawings and the written description, and thus, duplicative descriptions thereof may not be provided.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the singular forms “a,” “an” and “the” are intended to include the plural forms as well, unless the context clearly indicates otherwise.

Spatially relative terms, such as “on,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the drawings. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, such as an area, layer, film, region or portion, is referred to as being “on,” “connected to,” or “coupled to” another element, it can be directly on, connected to, or coupled to the other element, or one or more intervening elements may be present. In addition, it will also be understood that when an element is referred to as being “between” two elements, it can be the only element between the two elements, or one or more intervening elements may also be present. In contrast, when an element or layer is referred to as being “directly on,” “directly connected to”, “directly coupled to”, or “immediately adjacent to” another element or layer, there are no intervening elements or layers present.

As used herein, the term “and/or” includes any and all combinations of one or more of the associated listed items. Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from among a, b, and c,” “at least one from among a, b, and c,” “one from among a, b, and c”, “at least one of a to c” indicates only a, only b, only c, both a and b, both a and c, both b and c, all of a, b, and c, or variations thereof.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The terms used in this specification are for describing embodiments of the present disclosure and are not intended to limit the present disclosure.

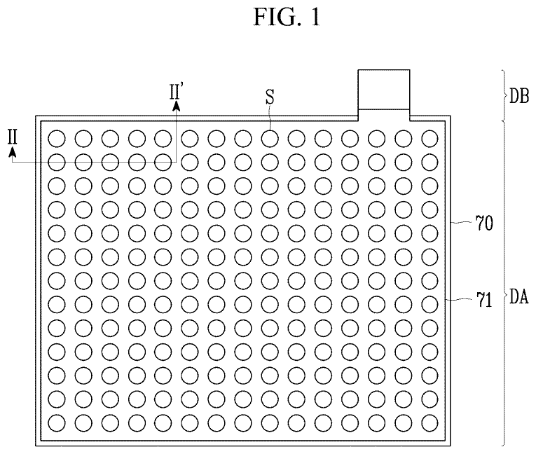

FIG. 1 is a top plan view showing a negative electrode included in a rechargeable battery according to one or more embodiments of the present disclosure,

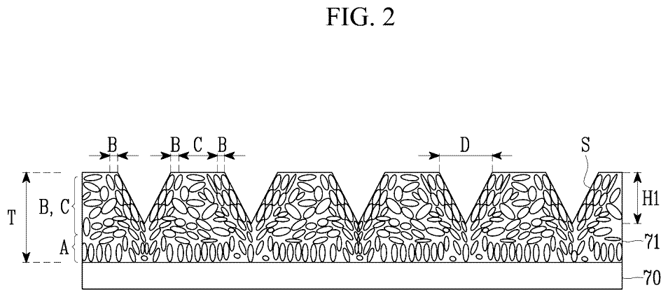

FIG. 2 is a cross-sectional view taken along the line II-II′ of FIG. 1, according to one or more embodiments of the present disclosure, and

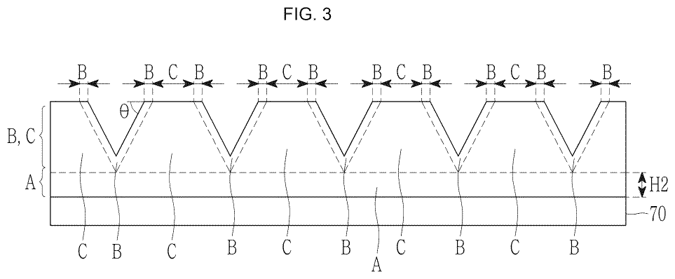

FIG. 3 is a cross-sectional view for describing a region of an active material layer according to one or more embodiments of the present disclosure.

As shown in FIGS. 1 and 2, the negative electrode according to one or more embodiments of the present disclosure includes a substrate 70 and an active material layer 71 arranged on a first surface of the substrate 70. The negative electrode will be described as an example of a sheet type or kind included in a stacked electrode assembly of a rechargeable battery, which will be described in more detail later, but the present disclosure is not limited thereto, and may also be used as an electrode in a wound type or kind of electrode assembly.

The substrate 70 may include an electrode active portion DA and an electrode non-active portion DB, the active material layer 70 may be arranged on the electrode active portion DA, and the electrode non-active portion DB may have a shape that protrudes from the electrode active portion DA in order to draw current outward.

The substrate 70 may be selected from among copper foil, nickel foil, stainless steel foil, titanium foil, nickel foam, copper foam, a polymer substrate coated with a conductive metal, and/or a (e.g., any suitable) combination thereof.

The active material layer 71 may be arranged at a side (e.g., one side or opposite sides) of and centered on the substrate 70 (e.g., centered on the electrode active portion DA of the substrate 70). That is, the active material layer 71 may be arranged on one side or both (opposite) sides of the substrate 70, centered on the electrode active portion DA of the substrate 70. The active material layer 71 includes a negative active material, and may further include a binder and/or a conductive material. For example, the negative active material layer (e.g., the active material layer 71) may include 90 wt % to 99 wt % of the negative active material, 0.5 wt % to 5 wt % of the binder, and 0 wt % to 5 wt % of the conductive material.

### Negative Active Material

The negative active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include a carbon-based negative active material, e.g., crystalline carbon, amorphous carbon, and/or a (e.g., any suitable) combination thereof. Examples of the crystalline carbon may include graphite such as amorphous, plate-shaped, flake-shaped, spherical or fibrous natural graphite or artificial graphite, and examples of the amorphous carbon may include soft carbon or hard carbon, mesophase pitch carbide, and calcined coke.

As the alloy of the lithium metal, an alloy of lithium with a metal selected from among Na, K, Rb, Cs, Fr, Be, Mg, Ca, Sr, Si, Sb, Pb, In, Zn, Ba, Ra, Ge, Al and Sn may be used.

A Si-based negative active material and/or a Sn-based negative active material may be used as a material capable of doping and dedoping lithium. The Si-based negative active material may be silicon, a silicon-carbon composite, a silicon oxide (SiOₓ, 0<x≤2), a Si-Q alloy (wherein Q is selected from among an alkali metal, an alkaline earth metal, a Group 13 element, a Group 14 element (excluding Si), a Group 15 element, a Group 16 element, a transition metal, a rare earth element, and/or a (e.g., any suitable) combination thereof), and/or a (e.g., any suitable) combination thereof. The Sn-based negative active material may include Sn, tin oxide, SnOₓ (0<x≤2), e.g., SnO₂, an Sn-based alloy, and/or a (e.g., any suitable) combination thereof.

The silicon-carbon composite may be a composite of silicon and amorphous carbon. According to one or more embodiments, the silicon-carbon composite may be in the form of silicon particles and amorphous carbon coated on surfaces of the silicon particles. For example, it may include a secondary particle (core) in which silicon primary particles are assembled and an amorphous carbon coating layer (shell) positioned on a surface of the secondary particle. The amorphous carbon may also be positioned between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles and an amorphous carbon coating layer positioned on a surface of the core.

The Si-based negative active material or Sn-based negative active material may be used by mixing it with a carbon-based negative active material.

The transition metal oxide may include, for example, any one or more of the transition metal oxides described below with reference to the positive active material.

### Binder

The binder serves to ensure that particles of the negative active material adhere to each other and also adhere the negative active material to the current collector. The binder may be a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, poly amide-imide, polyimide, and/or a (e.g., any suitable) combination thereof.

The aqueous binder may be selected from among styrene-butadiene rubber, (meth)acrylated styrene-butadiene rubber, (meth)acrylonitrile-butadiene rubber, (meth)acrylic rubber, butyl rubber, fluoroelastomer, polyethylene oxide, polyvinylpyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenol resin, epoxy resin, polyvinyl alcohol, and/or a (e.g., any suitable) combination thereof.

When an aqueous binder is used as the negative electrode binder, it may further contain a cellulose-based compound capable of imparting viscosity. As the cellulose-based compound, carboxymethyl cellulose, hydroxypropyl methyl cellulose, methyl cellulose, an alkali metal salt thereof, and/or the like may be used in combination. As the alkali metal, Na, K, or Li may be used.

The dry binder is a polymer material capable of being fiberized, and may be, e.g., polytetrafluoroethylene, polyvinylidene fluoride, polyvinylidene fluoride-hexafluoropropylene copolymer, polyethylene oxide, and/or a (e.g., any suitable) combination thereof.

### Conductive Material

The conductive material (e.g., electron conductor) is used to impart conductivity to the electrode, and any electronic conductive material that does not cause a chemical change in the battery may be used. Examples thereof may include, e.g., a carbon-based material such as natural graphite, artificial graphite, carbon black, acetylene black, Ketjen black, carbon fiber, and carbon nanotubes; a metallic substance including copper, nickel, aluminum, silver, and/or the like and in the form of metal powder or metal fiber; a conductive polymer such as polyphenylene derivative; and/or a (e.g., any suitable) mixture thereof.

Again, referring to FIGS. 1 to 3, a hole S may be formed in the active material layer 71, and an inner wall forming the hole S is inclined at a certain angle (θ) with respect to a surface of the active material layer 71. The angle (θ) may be about 30 degrees to about 75 degrees. Even if the angle of the hole S changes, a cross-sectional area may remain substantially the same. Accordingly, as the angle θ increases, a depth H1 of the hole S may become deeper, and as the angle θ decreases, a diameter D of the hole S may increase. That is, a hole S may be formed in the active material layer 71 with its inner wall inclined at an angle (θ) of about 30 degrees to about 75 degrees relative to the surface. Even if the angle changes, the cross-sectional area remains substantially the same. As the angle θ increases, the depth H1 of the hole S becomes deeper, and as the angle e decreases, the diameter D of the hole S increases. The depth H1 of the hole S may be 5% to 80% of the thickness of the active material layer, the diameter D may be 10 um to 100 um, and the density of the hole S may be 50 pt/mm² to 500 pt/mm².

As the distance from the surface of the active material layer 71 increases, the diameter of the hole S may decrease. A planar shape of the cross section parallel to the surface of the active material layer 71 may be circular or polygonal. Accordingly, the hole S may have a shape of a cone or a polygonal pyramid whose bottom is the same horizontal plane as the surface of the active material layer 71. Also, in the present disclosure, when the hole or holes are circular, “diameter” indicates a circle diameter, and when the hole or holes are non-circular, the “diameter” indicates a major axis length.

The active material layer 71 may include a negative active material, and the negative active material includes a first oriented portion A, a second oriented portion B, and a non-oriented portion C depending on a position thereof. Boundaries between the first oriented portion A, the second oriented portion B, and the non-oriented portion C are not clear, and at the boundaries, active material particles of the first oriented portion A and active material particles of the non-oriented portion C, or active material particles of the second oriented portion B and active material particles of the non-oriented portion C may exist together, so that oriented particles and non-oriented particles may exist together.

The first oriented portion A and the second oriented portion B each include active material particles oriented in different ways.

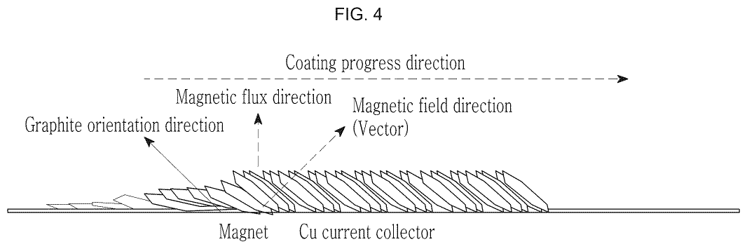

The active material particles in the first oriented portion A may be oriented by a magnetic field, and after orientation, the active material particles may be aligned to have a constant angle with respect to the substrate 70. This will be described in more detail with reference to FIG. 4.

FIG. 4 is a schematic view for describing magnetic field orientation of a negative active material according to one or more embodiments of the present disclosure.

In FIG. 4, a description thereof will focus on carbon among the negative active materials.

Referring to FIG. 4, an active material layer is formed by applying a negative active material while moving the substrate, and active material particles are aligned at a constant angle with respect to the substrate using a magnetic flux. The active material particles are a representative carbon particle, and has an elliptical structure with a long axis and a short axis, and the angle is an angle between the long axis and the substrate.

A magnetic field (magnetic flux) by a magnet may be formed in a direction normal (e.g., perpendicular) to the substrate, but the direction in which the magnetic field is generated may have a constant angle as a vector function depending on a coating speed (movement speed of a negative substrate), and thus the negative active material particles included in the negative active material composition may have a shape that stands up at a constant angle with respect to a surface of the negative substrate, that is, the negative active material particles may be oriented.

The orientation angle and direction of the negative electrode active material particles may be adjusted by the strength of the magnetic field applied to the active material layer, an exposure time to the magnetic field, and a viscosity of the negative active material composition.

In the orientation using the magnetic field shown in FIG. 4, the magnetic field may occur under the active material layer, so that a lower portion of the active material layer adjacent to the magnetic field may be aligned. Accordingly, a height H2 of the first oriented portion A may be less than ½ of a thickness T of the active material layer.

Referring again to FIGS. 2 and 3, the second oriented portion B may be positioned between two neighboring holes S, and may be formed in an oblique shape on the substrate (e.g. at an oblique angle relative to the substrate) along an inclined plane forming the hole S. The active material particles of the second oriented portion B may be erected to have a constant angle (θ) with respect to the surface of the substrate 70 such that a long axis thereof is parallel to the inclined surface. In this case, the inclined surface is not an inclined surface exposed inside the hole, but an external inclined surface having portions facing (e.g., opposite to) each other between two neighboring holes.

The second oriented portion B may be formed by moving the active material particles while forming the hole S, and the inclination angle (θ) of the active material particles of the second oriented portion B may be the same as the angle (θ) of the inclination surface of the hole S.

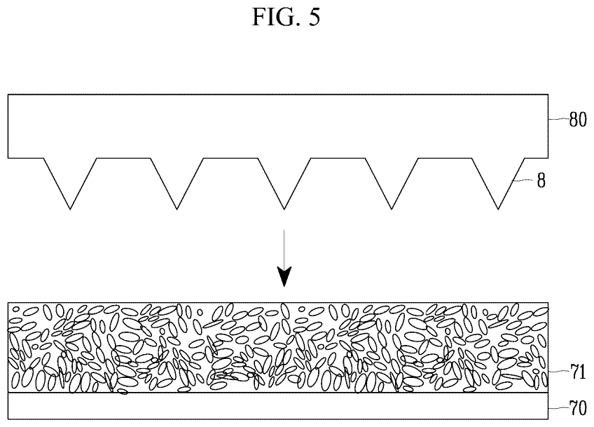

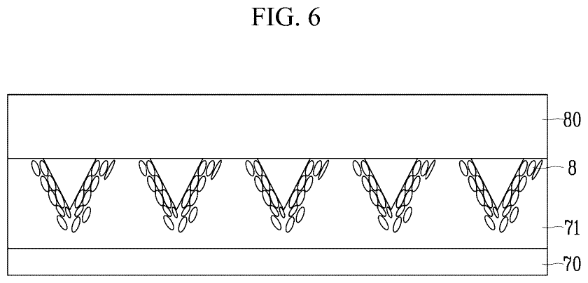

FIG. 5 and FIG. 6 are each a cross-sectional view for describing a method of forming a second orientation portion according to one or more embodiments of the present disclosure.

The second oriented portion B may be formed together with forming the hole S. Referring to FIG. 5, the hole S is formed by a physical method, for example, by pressing the active material layer 71 using a stamping device 80 having a protrusion 8 of the same shape as the hole S to be formed such that a hole is formed in the active material layer 71.

As shown in FIG. 6, as the protrusion 8 is inserted into the active material layer 71, the active material particles are pushed and moved by the protrusion 71, and the pushed active material particles stand along the inclined surface of the protrusion 8. The active material particles may be pushed and come into close contact with each other. Accordingly, density of the second oriented portion B may be higher than that of the non-oriented portion C, and density of the lower layer of the active material layer 71 may increase as it is pressed. For example, density of the second oriented portion B and the lower layer, which are portions of the entire active material layer 71, may increase (see, e.g., Table 1). In other words, as the protrusion 8 is inserted into the active material layer 71, the active material particles are pushed and aligned along the inclined surface of the protrusion 8, increasing the density of the second oriented portion B and the lower layer of the active material layer 71.

Referring again to FIGS. 2 and 3, unlike the oriented portion, the non-

oriented portion C does not undergo a separate orientation process, and thus active material particles having various directions and angles are mixed. For example, the non-oriented portion C may be less oriented than the aligned portions A and B. The non-oriented portion C may be positioned above the first oriented portion A and between second aligned portions B. All areas other than the first oriented portion A and the second oriented portion B may be non-oriented portions C.

The active material layer of the non-oriented portion C may have high direct current internal resistance because Li ions do not move relatively smoothly compared to the active material layers of the aligned portions A and B.

When a reference peak intensity ratio of a (110) plane to a (002) plane is set to 1 when measuring X-ray diffraction (XRD) using a CuKα line of the negative electrode, the peak intensity ratio of the (110) plane to the (002) plane of the oriented portion may be 1 or more. For example, I₍₁₁₀₎/I₍₀₀₂₎ of the non-oriented portion may be less than 1, and I₍₁₁₀₎/I₍₀₀₂₎ of the oriented portion may be greater than or equal to 1.

Table 1 is a table measuring density and orientation of Comparative Examples and Examples.

TABLE 1

| | hole | hole | Hole | hole | upper | lower | upper | lower |
|---|---|---|---|---|---|---|---|---|
| | diameter | depth | angle | density | density | density | orientation | orientation |
| | (μm) | (μm) | (°) | (Pt/mm²) | (g/cc) | (g/cc) | (I₁₁₀/I₀₀₂) | (I₁₁₀/I₀₀₂) |
| Comparative | | | | | 1.64 | 1.63 | 0.69 | 1.21 |
| Example 1 | | | | | | | | |
| Comparative | 60 | 30 | 45 | 110 | 1.67 | 1.66 | 1.31 | 0.54 |
| Example 2 | | | | | | | | |
| Example 1 | 72.1 | 20.8 | 30 | 110 | 1.69 | 1.63 | 1.35 | 1.2 |
| Example 2 | 60 | 30 | 45 | 110 | 1.63 | 1.64 | 1.68 | 1.26 |
| Example 3 | 50 | 43.3 | 60 | 110 | 1.61 | 1.66 | 2.15 | 1.44 |
| Example 4 | 38.7 | 72.2 | 75 | 110 | 1.59 | 1.68 | 2.84 | 1.8 |

Comparative Examples and Examples are active material layers formed with the same active material. Comparative Example 1 performed magnetic field orientation, Comparative Example 2 formed an about 45 degree hole (i.e., an about 45 degree hole relative to the upper surface of the active material layer), and Examples 1 to 4 performed magnetic field orientation and formed about 30 degree, about 45 degree, about 60 degree, and about 75 degree holes (where the degrees are measured relative to the upper surface of the active material layer), respectively. In other words, Comparative Examples and Examples were formed using the same active material. Comparative Example 1 involved magnetic field orientation, while Comparative Example 2 formed a hole at about 45 degrees relative to the upper surface of the active material layer. Examples 1 to 4 involved magnetic field orientation and formed holes at about 30 degrees, 45 degrees, 60 degrees, and 75 degrees, respectively, relative to the upper surface of the active material layer. Referring to Table 1, when magnetic field orientation is performed as in Comparative Example 1, an orientation degree of a lower portion of the active material layer is 1 or more, while an orientation degree of an upper portion is less than 1, indicating that the orientation degree is different at the lower and upper portions, and that the upper portion is not oriented (i.e., indicating different orientation degrees at the lower and upper portions, with the upper portion not being oriented).

Then, as in Comparative Example 2, when forming a hole, the upper portion of the active material layer where the hole is formed has an orientation degree of 1 or more, while the lower portion is unoriented and is less than 1 because there is no separate orientation process (i.e., due to the absence of a separate orientation process).

As in Examples 1 to 4 of the present disclosure, when magnetic field orientation is performed and holes are formed at angles of about 30, about 45, about 60, and about 75, it may be seen that the orientation increases, with both the lower and upper orientation degrees being 1 or more. In other words, when magnetic field orientation is performed and holes are formed at angles of about 30, 45, 60, and 75 degrees, it can be seen that the orientation increases, with both the lower and upper orientation degrees being 1 or more.

As such, in embodiments of the present disclosure, the orientation of the entire active material layer may be increased by using the magnetic field orientation and the physical orientation that forms the hole.

In addition, referring to Table 1, by comparing Comparative Example 1, in which no hole is formed, to in Examples 1 to 4, where a hole is formed, as the angle increases, composite density of the entire upper portion of the active material layer where a hole is formed decreases from 1.64 g/cc to 1.59 g/cc. In addition, it may be seen that total composite density of the lower portion of the active material layer increases from 1.63 g/cc in Comparative Example 1 to 1.68 g/cc as the angle of the hole increases as in Examples 1 to 4. In this way, the lower composite may be pressurized due to hole formation, thereby increasing the density.

As in embodiments of the present disclosure, if (e.g., when) the density of the upper layer is reduced, an ion movement path from a surface of the active material layer to inside the active material layer increases, thereby reducing resistance and improving electrolyte impregnation. Additionally, as the density of the lower layer increases, a contact area between the active material and the conductive material increases, thereby reducing resistance.

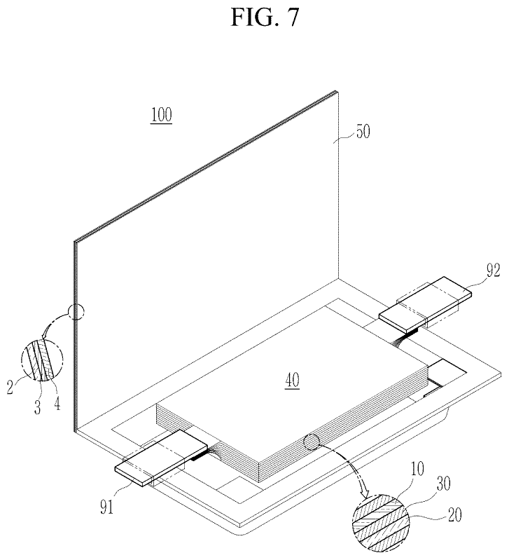

FIG. 7 is a schematic perspective view of a rechargeable battery according to one or more embodiments of the present disclosure.

A rechargeable battery according to one or more embodiments of the present disclosure includes an electrode assembly 40, a case 50 accommodating the electrode assembly 40 and an electrolyte.

The electrode assembly 40 is a stacked electrode assembly 40 in which a positive electrode 10 and a negative electrode 20 are repeatedly stacked with a separator 30 provided therebetween.

The separator 30, which is a polymer film that allows lithium ions to pass therethrough, may be made of polyethylene, polypropylene, polyvinylidene fluoride, or a multilayer film of two or more layers thereof, and may be used as a mixed multilayer membrane, such as polyethylene/polypropylene two-layer membrane, polyethylene/polypropylene/polyethylene three-layer membrane, polypropylene/polyethylene/polypropylene three-layer membrane, and/or the like.

The negative electrode 20 includes an electrode active portion in which an active material layer is arranged on a current collector of a substrate made of copper (Cu) and an electrode uncoated portion in which the substrate is exposed because an active material is not applied. The electrode uncoated portion that protrudes to the outside may be electrically connected an electrode tab 92 by welding, and may be connected to the electrode tab 92 to draw current to the outside.

The negative electrode 20 may be the negative electrode shown in FIGS. 1 and 3.

The positive electrode 10 may include an electrode active portion and an electrode non-active portion, an active material layer may be arranged on the electrode active portion, and the electrode non-active portion may have a shape that protrudes from the electrode active portion to draw current outward. The electrode uncoated portion that protrudes to the outside may be connected to an electrode tab 91 to draw current to the outside.

The substrate may be aluminum (Al), but the present disclosure is not limited thereto.

The active material layer may be arranged on a (e.g., one or both (e.g., opposite) sides) of the substrate. The active material layer may include a positive active material, and may further include a binder and/or a conductive material. A content (e.g., amount) of the positive active material in the positive active material layer may be 90 wt % to 99.5 wt % with respect to 100 wt % of the positive active material layer, and contents of the binder and the conductive material may be 0.5 wt % to 5 wt % with respect to 100 wt % of the positive active material layer.

### Positive active Material

As the positive active material, a compound capable of reversible intercalation and deintercalation of lithium (lithiated intercalation compound) may be used. For example, at least one of composite oxides of lithium and a metal selected from among cobalt, manganese, nickel, and/or a (e.g., any suitable) combination thereof may be used.

The above composite oxide may be a lithium transition metal composite oxide, and specific examples thereof may include a lithium nickel-based oxide, a lithium cobalt-based oxide, a lithium manganese-based oxide, a lithium iron phosphate-based compound, a cobalt-free nickel-manganese-based oxide, and/or a (e.g., any suitable) combination thereof.

As an example, a compound represented by any one selected from among the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤α≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn₁₋₆G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and/or LiₐFePO₄ (0.90≤a≤1.8).

In the above formulas, A indicates Ni, Co, Mn, and/or a (e.g., any suitable) combination thereof; X indicates Al, Ni, Co, Mn, Cr, Fe, Mg, Sr, V, a rare earth element, and/or a (e.g., any suitable) combination thereof; D indicates O, F, S, P, and/or a (e.g., any suitable) combination thereof; G indicates Al, Cr, Mn, Fe, Mg, La, Ce, Sr, V, and/or a (e.g., any suitable) combination thereof; and L¹ indicates Mn, Al, and/or a (e.g., any suitable) combination thereof.

As an example, the positive active material may be a high nickel-based positive active material having a nickel content (e.g., amount) of 80 mol % or more, 85mol % or more, 90 mol % or more, 91 mol % or more, or 94 mol % or more and 99 mol % or less with respect to 100 mol % of metals other than lithium in a lithium transition metal composite oxide. High-nickel-based positive active materials may achieve high capacity, and may be applied to high-capacity, high-density lithium rechargeable batteries.

### Binder

The binder serves to ensure that particles of the positive active material adhere to each other and also to adhere the positive active material to the current collector. Representative examples of binders include polymers including polyvinyl alcohol, carboxymethyl cellulose, hydroxypropyl cellulose, diacetyl cellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, and/or the like, but the present disclosure is not limited thereto.

### Conductive Material

The conductive material (e.g., electron conductor) is used to impart conductivity to the electrode, and any electronic conductive material that does not cause a chemical change in the battery may be used. Examples of the conductive material may include, e.g., a carbon-based material such as natural graphite, artificial graphite, carbon black, acetylene black, Ketjen black, carbon fiber, and carbon nanotubes; a metallic substance including copper, nickel, aluminum, silver, and/or the like, and in the form of metal powder or metal fiber; a conductive polymer such as polyphenylene derivative; and/or a (e.g., any suitable) mixture thereof.

The electrode assembly 40 may be accommodated together with an electrolyte in a pouch-shaped or can-shaped prismatic case and used as a rechargeable battery.

The electrolyte contains a non-aqueous organic solvent and a lithium salt. The non-aqueous organic solvent serves as a medium through which ions involved in the electrochemical reaction of the battery may move.

The lithium salt is dissolved in an organic solvent and acts as a source of lithium ions in the battery, enabling an operation of a basic lithium rechargeable battery, and is a substance that promotes movement of lithium ions between the positive and negative electrodes. Representative examples of such lithium salts include one or two or more selected from among LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CxF₂ₓ₊₁SO₂)(CyF_{2y+1}SO₂) (where x and y are natural numbers, e.g., integers from 1 to 20), LiCl, Lil, and/or LiB(C₂O₄)₂ lithium bis(oxalato) borate (LiBOB) as a supporting electrolytic salt.

A concentration of the lithium salt is within a range of about 0.1 M to 2.0 M.

In a case where a concentration of lithium salt is within an above range, the electrolyte has appropriate or suitable conductivity and viscosity so as to exhibit excellent or suitable electrolyte performance, and to allow lithium ions to effectively move.

The pouch-type or kind case 50 may be formed of a laminated exterior material, and the laminated exterior material may be formed of a multilayer structure including, e.g., a first insulating layer 2, a metal layer 3, and a second insulating layer 4. Of course, one or more suitable other adhesive layers or functional layers may be added.

The first insulating layer 2 may be formed of a material having insulating and thermal adhesive characteristics on an inner surface of the laminated outer material, to be sealed by thermally fusing edges while the electrode assembly 40 is accommodated. Additionally, the first insulating layer 2 is arranged on a first surface of the metal layer 3, and forms an inner surface of the laminate exterior material facing (e.g., opposite to) the electrode assembly 40. The first insulating layer 2 may be formed of casted polypropylene (CPP) or its equivalent, which does not react with electrolyte.

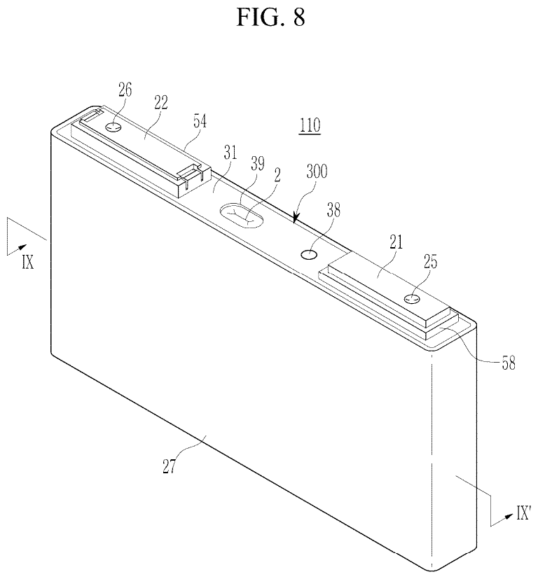

FIG. 8 illustrates a schematic perspective view of a rechargeable battery according to one or more embodiments of the present disclosure, and

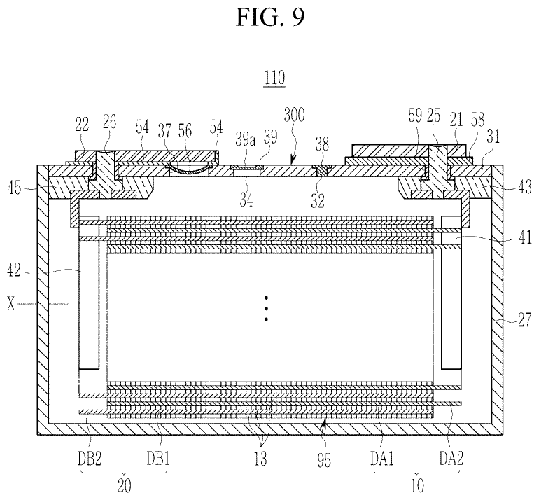

FIG. 9 is a cross-sectional view taken along the line IX-IX′ of FIG. 8, according to one or more embodiments of the present disclosure.

As illustrated in FIGS. 8 and 9, the rechargeable battery 110 according to one or more embodiments of the present disclosure includes an electrode assembly 95, a case 27 accommodating the electrode assembly 95, and a cap assembly 300 installed in an opening of the case 27.

The electrode assembly 95 includes a positive electrode 10 and a negative electrode 20 that are sequentially stacked, and a separator 13 positioned therebetween. The separator 13 is positioned between the positive electrode 10 and the negative electrode 20 and insulates them.

The electrode assembly 95 may be a jelly roll type or kind in which the positive electrode (or first electrode) 10 and the cathode (or second electrode) 20 are wound around a winding axis with the separator 13 therebetween and then are pressed flat.

The positive electrode, separator, and negative electrode are almost the same as (similar to) the positive electrode, separator, and negative electrode of the rechargeable battery shown in FIG. 7, so different portions will be specifically described.

The positive electrode 10 and the negative electrode 20 may include electrode active portions DA1 and DB1 and electrode uncoated portions DA2 and DB2, and the positive substrate and the negative substrate may be in the form of a long strip in a direction, and the electrode uncoated portions DA2 and DB2 may be positioned at a first end along the length direction of the substrate.

The electrode uncoated portion DA2 of the positive electrode 10 and the electrode uncoated portion DB2 of the negative electrode 20 may be positioned at opposite sides of the electrode active portions DA1 and DB1.

In one or more embodiments, the electrode uncoated portions of the positive and negative electrodes may each have a shape that protrudes at regular intervals along a direction in which the substrate is wound, or may be positioned at a tip or end of the wound electrode assembly.

In one or more embodiments, the electrode assembly 95 may be accommodated in the case 27 together with the electrolyte.

The case 27 may be made of a metal such as aluminum, and may have a substantially rectangular parallelepiped shape. A first side of the case 27 may be open, and a cap plate may be installed at the open side of the case 27.

The cap assembly 300 includes a cap plate 31 coupled to the case 27 to block and/or close the opening of the case 27, and a positive terminal 21 electrically connected to the positive electrode 10 and a negative terminal 22 electrically connected to the negative electrode 20, each of which protrudes to the outside of the cap plate 31.

The cap plate 31 is formed in the form of an elongated plate extending in a direction, and is coupled to the opening of the case 27.

The cap plate 31 has an inlet 32 that extends through the cap plate 31 to an interior of the case 27. The inlet 32 is for injecting electrolyte, and a sealing stopper 38 is installed therein. Furthermore, a vent plate 39 with a notch 39a is installed in the vent hole 34 such that the cap plate 31 can be opened at a set or predetermined pressure.

The positive terminal 21 and the negative terminal 22 are installed to protrude above the cap plate 31. The positive terminal 21 is electrically connected to the positive electrode 11 through a current collection tab 41, and the negative terminal 22 is electrically connected to the negative electrode 12 through a current collection tab 42.

A terminal connection member 25 is installed between the positive terminal 21 and the current collection tab 41 to electrically connect the positive terminal 21 and the current collection tab 41. The terminal connection member 25 is inserted into the hole formed in the positive terminal 21, an upper end thereof is fixed to the positive terminal 21 by welding, and a lower end thereof is fixed to the current collection tab 41 by welding.

A gasket 59 for sealing is inserted into a hole through which the terminal connection member 25 extends between the terminal connection member 25 and the cap plate 31, and a lower insulating member 43 into which a lower portion of the terminal connection member 25 is inserted is installed below the cap plate 31. A connection plate 58 is installed between the positive terminal 21 and the cap plate 31 to electrically connect them. The terminal connection member 25 is installed by being inserted into the connection plate 58. Accordingly, the cap plate 31 and the case 27 are charged with the positive electrode 10.

A terminal connection member 26 is installed between the positive terminal 22 and the current collection tab 42 to electrically connect the positive terminal 22 and the current collection tab 42. The terminal connection member 26 is inserted into the hole formed in the negative terminal 22, an upper end thereof is fixed to the negative terminal 22 by welding, and a lower end thereof is fixed to the current collection tab 42 by welding.

Between the negative terminal 22 and the cap plate 31, a gasket 59 for sealing is inserted and installed into a hole through which the terminal connection member 26 extends, and an upper insulating member 54 is installed to insulate between the negative terminal 22 and the cap plate 31. The terminal connection member 26 may be installed by fitting it into the hole of the upper insulating member 54, and the upper insulating member 54 may be formed to be around (e.g., surround) an end of the terminal connection member 26 and/or the negative terminal 22.

Furthermore, a lower insulating member 45 is installed below the cap plate 31 to insulate the negative terminal 22 and the current collection tab 42 from the cap plate 31.

A short-circuiting hole 37 is formed in the cap plate 31, and a short-circuiting member 56 is installed in the short-circuiting hole 37. The short-circuiting member 56 includes a curved portion convexly curved downward in an arc shape and an edge portion positioned on the outside of the curved portion and fixed to the cap plate 31. The upper insulating member 54 may have a cutout that overlaps the shorting hole 37, and the short-circuiting member 56 may overlap the negative terminal 22 exposed through the cutout.

The short-circuiting member 56 is electrically connected to the cap plate 31, and is deformed in a case where an internal pressure of the rechargeable battery 1000 increases, causing a short-circuit between the positive electrode and the negative electrode. For example, if (e.g., when) a gas is generated in the rechargeable battery due to an abnormal reaction, the internal pressure of the rechargeable battery rises. In a case where the internal pressure of the rechargeable battery becomes higher than a set or predetermined pressure, a curved portion is deformed to be convexly upward, and in embodiments of the present disclosure, the negative terminal 22 and the short-circuiting member 56 come into contact, causing a short-circuit.

In order to facilitate short-circuiting between the negative terminal 22 and the short-circuiting member 56, the negative terminal 22 may further include at least one protrusion protruding toward the short-circuiting member 56, and the protrusion may be spaced and/or apart (e.g., spaced apart or separated) from the short-circuiting member 56.

In the above embodiments, a rechargeable battery including a square case has been described, but the present disclosure is not limited thereto, and may include a cylindrical case.

Table 2 is a table measuring electrical characteristics of rechargeable batteries according to the Comparative Examples and Examples described above with reference to Table 1.

TABLE 2

| | | | | | | Low |
|---|---|---|---|---|---|---|
| | Electrolyte | Rate | Rate | | Rapid | temperature |
| | impregnation | charge | discharge | Rᵢₒₙ | lifespan | lifespan |
| | (s@1 μl) | (%@3.0 C) | (%@3.0 C) | (Ωcm²) | (%@500 cycle) | (%@500 cycle) |
| Comparative | 257 | 35.8 | 88.6 | 23.8 | 67.5 | 48.9 |
| Example 1 | | | | | | |
| Comparative | 126 | 58.9 | 90.3 | 16.4 | 75.3 | 68.8 |
| Example 2 | | | | | | |
| Example 1 | 198 | 50.4 | 89.4 | 19.5 | 71.6 | 60.1 |
| Example 2 | 111 | 60.1 | 93.1 | 15.1 | 77.5 | 70.6 |
| Example 3 | 98 | 65.5 | 95.4 | 12.3 | 82.7 | 74.9 |
| Example 4 | 65 | 73.8 | 98.3 | 7.5 | 86.9 | 78.3 |

Electrolyte impregnation is measured by a time it takes to absorb 1 μl, Rᵢₒₙ is a resistance value that affects lithium ion movement, a lower resistance value indicates that lithium ions move smoothly, and a higher resistance value indicates that lithium ions do not move smoothly.

Rate discharge and rate charge were measured with a 7.5 Ah square cell.

Rapid lifespan characteristics were measured by charging the rechargeable batteries manufactured by comparative examples and examples at a constant current of 1.0 C rate at 25° C. until the voltage reached 4.2V, and then cutting off at a current of 0.05 C rate while maintaining 4.2V in constant voltage mode. Subsequently, one cycle of discharging at a constant current of 1.0 C rate was repeated 500 times until the voltage reached 2.5V.

In all of the above charge/discharge cycles, a 10-minute pause was allowed after one charge/discharge cycle. A ratio of the 500-time discharge capacity to the 1-time discharge capacity was calculated and listed in Table 2.

Low-temperature lifespan characteristics were measured by charging the rechargeable batteries manufactured by comparative examples and examples at low temperature (15° C.) at a constant current of 0.5 C rate at 15° C. until the voltage reached 4.2V, and then cutting off at a current of 0.05 C rate while maintaining 4.2V in constant voltage mode. Subsequently, one cycle of discharging at a constant current of 0.5 C rate was repeated 500 times until the voltage reached 2.5V.

In all of the above charge/discharge cycles, a 10-minute pause was allowed after one charge/discharge cycle. A ratio of the 500-time discharge capacity to the 1-time discharge capacity was calculated and listed in Table 2.

Referring to Table 2, it may be seen that compared to Comparative Example 1, the electrolyte impregnability, rate charge, rate discharge, and Rᵢₒₙ characteristics of Examples 1 to 3 were improved, and rapid charge and low temperature lifespan characteristics were also increased.

It may be seen that compared to Comparative Example 2, the electrolyte impregnability and rapid lifespan in Example 1 are reduced, but the rate charge, rate discharge, and Rion characteristics are improved, and the low-temperature lifespan is increased.

Accordingly, by adjusting the angle of the hole, it is possible to manufacture a rechargeable battery that matches desired or required electrical characteristics.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, a device for manufacturing the battery, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. It is to be understood that the foregoing is an illustration of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

Reference Numerals

| | |
|---|---|
| 8: protrusion | 40, 95: electrode assembly |
| 70: substrate | 71: active material layer |
| 80: stamping device | 100, 110: rechargeable battery |

What is claimed is:

1. A negative electrode comprising:
a substrate; and
an active material layer on the substrate and comprising:
a lower layer, and
an upper layer on the lower layer and having a plurality of holes with an inclined sidewall,
wherein the lower layer comprises a first oriented portion, and the upper layer comprises second oriented portions and a non-oriented portion between the second oriented portions, and
wherein the negative electrode is for a rechargeable battery.

2. The negative electrode of claim 1, wherein a long axis of active material particles in the second oriented portions is oriented in a direction parallel to the inclined sidewall.

3. The negative electrode of claim 1, wherein the first oriented portion is denser than the non-oriented portion.

4. The negative electrode of claim 1, wherein the inclined sidewall is inclined at an angle of about 30 degrees to about 75 degrees with respect to a surface of the substrate.

5. The negative electrode of claim 1, wherein the first oriented portion is a magnetic field oriented portion.

6. The negative electrode of claim 1, wherein the first oriented portion and the second oriented portions have different orientation angles.

7. The negative electrode of claim 1, wherein a thickness of the lower layer is less than half (½) of an entire thickness of the active material layer.

8. The negative electrode of claim 1, wherein a diameter of a hole of the plurality of holes becomes narrower toward the lower layer.

9. The negative electrode of claim 8, wherein the hole has a cone or polygonal shape.

10. A manufacturing method, the method comprising:
forming an active material layer on a substrate;
forming a first oriented portion by orienting the active material layer utilizing a magnetic field;
pressurizing the active material layer with a pressurizing device having a protrusion;
inserting the protrusion into the active material layer, and
forming a hole by removing the pressurizing device,
wherein, when the protrusion is inserted into the active material layer, active material particles of the active material layer are pushed out by the protrusion and are aligned to form a second oriented portion, and
wherein the method is a manufacturing method for a negative electrode for a rechargeable battery.

11. The manufacturing method of claim 10, wherein
an orientation angle of active material particles in the second oriented portion is different from an orientation angle of active material particles in the first oriented portion.

12. A rechargeable battery comprising the negative electrode according to claim 1.

13. A rechargeable battery comprising the negative electrode manufactured according to claim 10.
